(19) United States
(12) Patent Application Publication
(10) Pub. No.: US 2012/0102043 A1
(43) Pub. Date: Apr. 26, 2012

(54) Data Driven Metric for Service Quality

(75) Inventor: Ashish Verma, New Delhi (IN)

(73) Assignee: IBM Corporation, Armonk, NY (US)

(21) Appl. No.: 12/908,253

(22) Filed: Oct. 20, 2010

(51) Int. Cl. G06F 17/30

(52) U.S. Cl. 707/748; 707/756; 707/E17.044

(57) ABSTRACT

A data processing system establishes a mapping between each of a plurality of plurality of internal data sources within a service organization and a respective one of multiple service quality factors. The data processing system determines a mathematical transformation of internal service quality data obtained from the plurality of internal data sources to obtain a customer satisfaction value. The data processing system estimates and reports a service quality delivered by the service organization by applying the mathematical transformation to at least some of the internal service quality data obtained from the plurality of internal data sources.

### BACKGROUND OF THE INVENTION

1. Technical Field

The present invention relates in general to data processing, and in particular, to obtaining a data driven metric for service quality.

2. Description of the Related Art

For service organizations, such as service businesses, governmental agencies, non-profit associations, educational institutions and the like, maintaining high service quality for the services delivered by the service organization to its customers is essential to success of the mission of the service organization. Various service quality factors have been proposed in the literature in an attempt to provide criteria for assessing service quality.

Often, these service quality factors reference abstract concepts, such as tangibility, responsiveness, reliability, assurance, and empathy. Tangibility can be generally described as the customer's perception of physical facilities, equipment, personnel, and communications of the service organization. Responsiveness is the customer's perception of the willingness of the service organization and its representatives to help customers and provide prompt service. Reliability refers to the customer's perception of the ability of the service organization to perform the promised service dependably and accurately. Assurance can be described as the customer's perception of the knowledge and courtesy of the service organization's personnel and their ability to inspire trust and confidence. Finally, empathy refers the customer's perception of the service organization and its personnel as caring and providing individualized attention to its customers.

Because the service quality factors generally referenced in the literature are abstract and may depend solely upon customer's subjective perceptions of service quality by the customers, service organizations may attempt to obtain information regarding service quality by surveying some or all customers following provision of the services. However, service quality survey data can be expensive to collect, and not all customers are willing, for example, due to the time and effort involved, to provide ongoing detailed survey responses. Further, because the service quality survey data is by its nature subjective, it may not in all cases provide a satisfactory measure of the service organizations efforts to attain and maintain service quality.

### SUMMARY OF THE INVENTION

In some embodiments, a data processing system establishes a mapping between each of a plurality of internal data sources within a service organization and a respective one of multiple service quality factors. The data processing system then determines a mathematical transformation of internal service quality data obtained from the plurality of internal data sources to obtain a customer satisfaction value. The data processing system estimates and reports a service quality delivered by the service organization by applying the mathematical transformation to at least some of the internal service quality data obtained from the plurality of internal data sources.

### BRIEF DESCRIPTION OF THE DRAWINGS

FIG. 1 is a high level block diagram of a data processing environment in accordance with one embodiment;

FIG. 2 is a high level logical flowchart of an exemplary method of estimating service quality delivered by a service organization; and

FIG. 3 is a high level block diagram of an exemplary contact center environment in accordance with one embodiment.

### DETAILED DESCRIPTION OF ILLUSTRATIVE EMBODIMENT

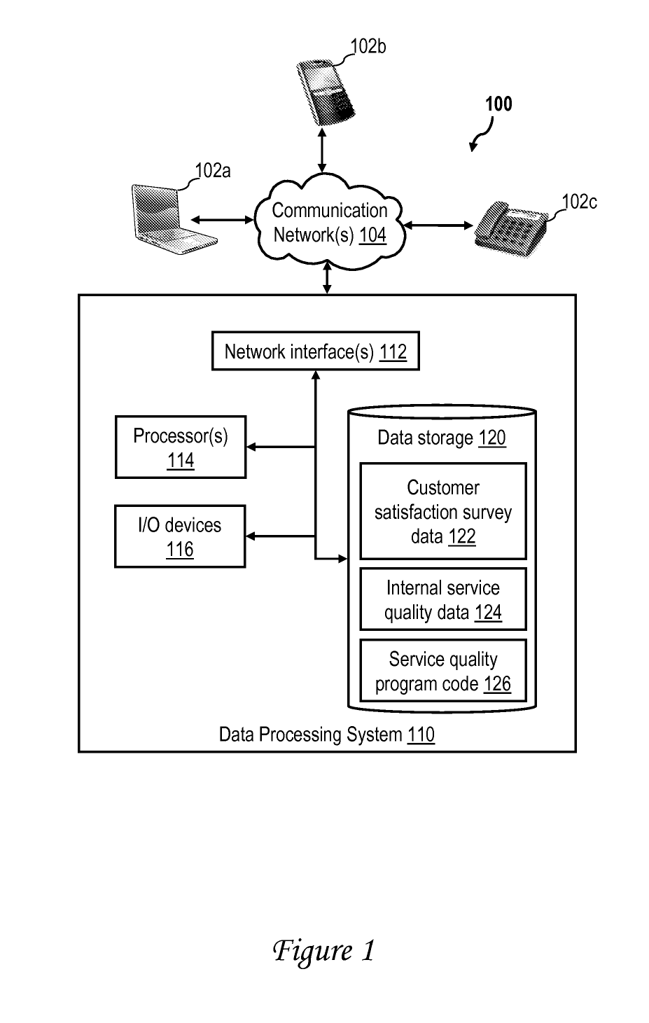

With reference now to the figures and with particular reference to FIG. 1, there is illustrated a high level block diagram of an exemplary data processing environment 100 in accordance with one embodiment. As shown, exemplary data processing environment 100 includes a data processing system 110, which can be operated by a service organization such as a service business, governmental agency, non-profit association, educational institution or the like. Alternatively, data processing system 110 can be operated by another party or organization that assesses the service quality of services provided by the service organization.

Data processing system 110 is coupled for communication to one or more circuit switched or packet switched communication networks 104, such as wired or wireless local area or wide area network(s), cellular telephony network(s), and/or public switched telephone network(s) (PSTNs). Thus, data processing system 110 may communicate with devices 102a-102c (e.g., computer systems, mobile telephones, smart phones, landline telephones) via communication network(s) 104. The communication between devices 102-102c and data processing system 110 can include voice communication, for example, via a PSTN or voice over Internet Protocol (VoIP) connection, and/or data communication, for example, via instant messaging, Simple Mail Transport Protocol (SMTP) or Hypertext Transfer Protocol (HTTP). In embodiments in which data processing system 110 is operated by the service organization, the communication between data processing system 110 and devices 102 can include the transmission of service requests from devices 102 to data processing system 110 and the transmission of service responses from data processing system 110 to devices 102.

Still referring to FIG. 1, data processing system 110, which can include one or more physical computer systems, includes one or more network interfaces 112 that permit data processing system 110 to communicate over communication networks 104. Data processing system 110 additionally includes one or more processors 114 that execute program code, for example, in order to deliver services to devices 102 and/or to monitor and characterize service quality. Data processing system 110 also includes input/output (I/O) devices 116, such as ports, displays, and attached devices, etc., which receive inputs and provide outputs of the processing performed by data processing system 110. Finally, data processing system 110 includes data storage 120, which may include one or more volatile or non-volatile storage devices, including memories, optical or magnetic disk drives, tape drives, etc.

Data storage 120 stores data and program code, which can be processed and/or executed to deliver services to devices 102 and/or to monitor and characterize the service quality of such services. In the depicted embodiment, the data and program code stored by data storage 120 includes customer satisfaction survey data 122, which provides a subjective assessment of the satisfaction of the customers/requesters of the service organization with the service(s) provided by the service organization. Data storage 120 additionally includes internal service quality data 124, which is defined as objective, quantifiable data measurable within the service organization that correlates to the service quality of the service(s) provided by the service organization to customers/requesters of the service organization. Data storage 120 may additionally include service quality program code 126 that, when processed by processor(s) 114, causes service provider system 100 to monitor and/or to characterize the service quality of the services provided by the service organization, as described further below.

It will be appreciated upon review of the foregoing description, the form in which data processing system 110 is realized can vary between embodiments based upon one or more factors, for example, the type of service organization, the type and number of services offered by the service organization, the type and number of customers of the services offered by the service organization, and the type and number of data sources within the service organization for internal service quality data 124. All such implementations, which may include, for example, one or more handheld, notebook, desktop, or server computer systems, are contemplated as embodiments of the inventions set forth in the appended claims.

As described above, service organizations, such as service businesses, governmental agencies, non-profit associations, educational institutions and the like, desire to maintain high service quality for the services delivered by the service organization to its customers. Attaining and maintaining service quality is not only essential to success of the mission of the service organization, but also may impact the service organization financially, for example, through contracts in which compensation of the service organization and/or the customers, contract renewal, and/or contract termination depend upon the service organization attaining and/or maintaining a specified service quality. Such contracts, often referred to as Service Level Agreements (SLAs), are common in certain industries, such as the customer support/contact center industry.

While SLA or similar performance-related contract provisions inject a desired level of accountability in the provision of services, establishing verifiable targets for service quality and measuring service quality has proved to be difficult in practice. Conventional service quality survey data, such as that described above, can be utilized to provide service quality targets or benchmarks and then to measure service quality. However, as noted above, service quality survey data is expensive to collect and its collection can be a significant factor in the cost of provision of the service to the customers (and potentially, the ultimate cost borne by the customer). Further, service quality survey data is subjective by its very nature in that it captures the customers' subjective perceptions of service quality, not objective metrics of service provision. Service quality survey data may also be sparse in that the percentage of customers to whom services are provided by the service organization who are willing to provide a service quality survey response may be small. The service quality survey sample may further be skewed by overrepresentation of customers having a strongly negative or strongly positive perception of service quality, as those customers having a more moderate perception of service quality may be less likely to provide a survey response. Paradoxically, presenting customers with a service quality survey in conjunction with provision of services can also lower customer satisfaction or perception of service quality, given the additional time and effort required to respond or to decline response to the service quality survey. The extent of the negative response to a service quality survey is directly related to the rigor of the service quality survey in exploring the various factors or dimension of service quality. Because of the cost and other disadvantages associated with service quality surveys, direct assessment of service quality through surveying is often not practical. Even in cases in which service quality is surveyed, customer satisfaction is surveyed only at a very high level, for example, by asking consumers to rate satisfaction with the service on a scale from 1-10.

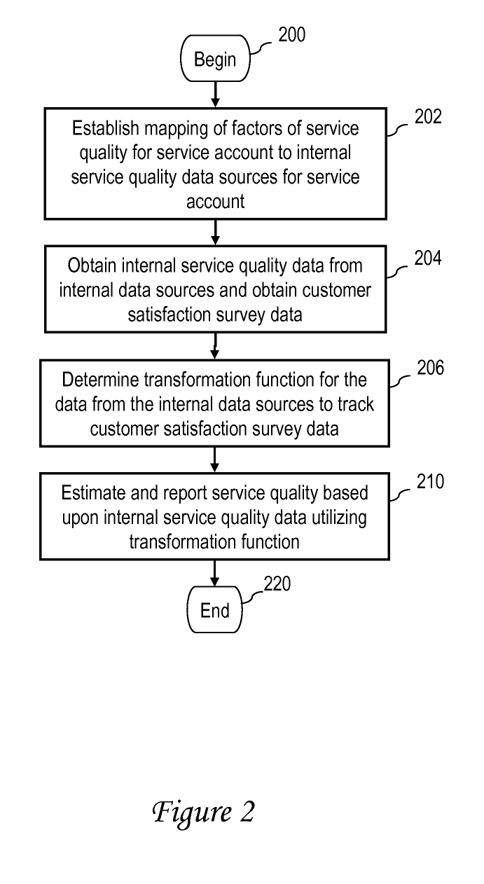

Despite the difficulties with directly assessing service quality through customer surveys, service quality can be estimated based upon objective, quantifiable data metrics as further described herein. Referring now to FIG. 2, there is depicted a high level logical flowchart of an exemplary process for estimating service quality of a service provided by a service organization. The process shown in FIG. 2 may be implemented, for example, by execution of service quality program code 126 of FIG. 1 by one or more processors 114 of data processing system 110. As a logical flowchart, it should be understood that FIG. 2 presents various steps in the process in logical rather than chronological order. Accordingly, in various implementations, one or more of the illustrated steps can be performed in an alternative order or contemporaneously.

The process begins at block 200 and then proceeds to block 202, which depicts data processing system 110 establishing a mapping between a plurality of factors of service quality for a given service account and internal data sources present in the service organization that are relevant to the service account. For example, if the five conventional factors of service quality are adopted, data processing system 110 maps each of tangibility, responsiveness, reliability, assurance, and empathy to one or more data sources within the service organization. It should be appreciated that in various embodiments and for various service accounts, data processing system 110 can map the data sources within the service organization relevant to service quality to a greater or fewer number of service quality factors and/or to different service quality factors.

At block 204, data processing system 110 obtains internal service quality data 124 from the internal data sources mapped at block 202. In various embodiments, internal service quality data 124 can be directly monitored and captured by data processing system 110 or can be loaded by data processing system 110 from one or more other sources (e.g., local or remote database(s)). In addition, at block 204 data processing system 110 obtains customer satisfaction survey data 122 relevant to the provision of services to customers by the service organization. It should be noted that customer satisfaction is distinct from, and easier and less expensive to survey, than service quality because customer satisfaction can be assessed without exploring the multiple dimensions of service quality (and can even be measured with a survey having a single question/response). Consequently, the high cost and other disadvantages associated with service quality surveys can be reduced or eliminated. As with the internal service quality data, in various embodiments customer satisfaction survey data 122 can be directly monitored and captured by data processing system 110 (e.g., via a webpage or interactive voice response (IVR) system) or can be loaded by data processing system 110 from another source (e.g., database).

Having obtained internal service quality data 124 from the internal data sources mapped to the service quality factors and customer satisfaction survey data 122, data processing system 110 determines a transformation function for the internal service quality data 124 obtained for the internal data sources mapped to the service quality factors to track the customer satisfaction survey data 122 (block 206). The transformation function can include any known or future developed mathematical transformation, including, for example, polynomial or geometric curve fitting functions. The transformation function can thereafter be tuned over time as needed to track customer satisfaction survey data 122. Utilizing the transformation function, data processing system 110 estimates and reports (i.e., stores, forwards and/or outputs) the service quality for the service account based upon internal service quality data 124 (block 210). In an exemplary embodiment, the service quality estimation depicted at block 210 is performed at regular intervals, which may be specified, for example, in a SLA of the service organization. The process depicted at FIG. 2 ends at block 220.

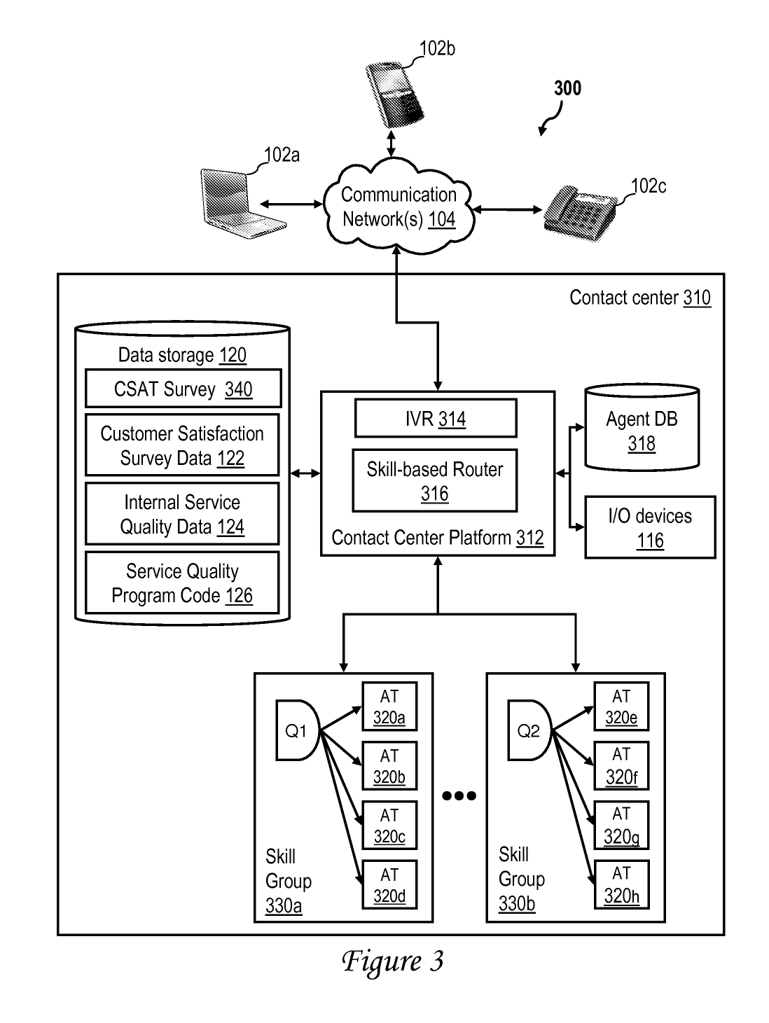

It should be understood that the inventive methodology depicted in FIG. 2 can be applied to any number of different service organizations and services, as well as to any number of service quality factors and internal service quality data sources. Thus, the methodology and the appended claims should not be construed as limited to a particular service organization or type of service. However, in order to facilitate a better understanding of the inventive methodology, a specific application of the inventive methodology to a contact center environment is described below with reference to FIG. 3.

With reference now to FIG. 3, there is illustrated a high level block diagram of a contact center environment 300 in accordance with one embodiment. In FIG. 3, like reference numerals are utilized to identify elements that are like or similar to those shown in FIG. 1.

As shown, contact center environment 300 includes a contact center 310 coupled for communication to one or more circuit switched or packet switched communication networks 104, such as wired or wireless local area or wide area network(s), cellular telephony network(s), and/or public switched telephone network(s) (PSTNs). Thus, contact center 100 may communicate with requester devices 102a-102c (e.g., computer systems, mobile telephones, smart phones, landline telephones) via communication network(s) 104. The communication between requester devices 102-102c and contact center 310 can include voice communication, for example, via a PSTN or voice over Internet Protocol (VoIP) connection, and/or data communication, for example, via instant messaging, Simple Mail Transport Protocol (SMTP) or Hypertext Transfer Protocol (HTTP). In general, the communication between contact center 100 and requester devices 102 includes the transmission of service requests from requester devices 102 to contact center 310 and the transmission of service responses from contact center 310 to requester devices 102.

Contact center 310 includes a contact center platform 312, which may include one or more physical computer systems including processing units, communication hardware and data storage. As indicated, contact center platform 312 can include, in addition to the possibly conventional processing, data storage and communication hardware, an interactive voice response (IVR) system 314. IVR system 314, which may comprise hardware and/or software components, provides automated voice interaction with a requester that establishes voice communication via one of requester devices 102a-102c. Thus, for example, IVR 314 may answer VoIP or PSTN calls and gather diagnostic information regarding a service request, as is known in the art.

Contact center platform 312 also includes a skill-based router 316 that routes service requests to agents for servicing. As indicated by its name, skill-based router 316 routes service requests to agents based, at least in part, on the skills associated with the agents by individualized agent skill records comprising agent database 318. Skill-based router 316 may, of course, consider additional factors in the routing of service requests to agents, including, for example, least-cost routing techniques, prior agent-requester relationship, workload balancing, agent availability, service level agreements, request escalation, etc. In at least some embodiment, skill-based router 316 is implemented as program code executable from the data storage 120 of contact center platform 312.

Contact center 310 further includes a plurality of agent terminals 320a-320h, which are coupled for communication with contact center platform 312 and which are utilized by live agents to conduct data and voice communication with requester devices 102. Agent terminals 320 may be geographically distributed from contact center platform 312 and may further be geographically distributed from one another. Although not required, agent terminals 320 may be logically (and possibly physically) grouped in one or more possibly intersecting skill groups, such as skill groups 330a-330b, which include agent terminals 320 of agents possessing the same or similar skill sets.

As indicated by request queues Q1 and Q2, in some cases skill-based router 316 may further route service requests to a request queue Q1 or Q2 for servicing by an agent stationed at any of agent terminals 320 in a particular skill group 330, rather than routing a request directly to a specific agent terminal 320. Service requests queued to one of queues Q1 and Q2 may thereafter be handled, for example, at the agent terminal 320 of the first available agent.

To permit timely servicing of service requests in the absence (or unavailability) of one or more agents in a given skill group 330, the agent skill records of agent database 318 may further designate one or more agents outside of a particular skill group 330 as a backup agent of that skill group 330 generally or of one or more particular primary agents in that skill group 330. Thus, for example, agent database 318 may designate an agent stationed at agent terminal 320e as a backup agent of skill group 330a generally, or as a backup agent of one or more particular primary agents in skill group 330a, such as the agent stationed at agent terminal 320a. With this arrangement, if no primary agent in skill group 330a is available to timely handle a service request, that service request may be routed to the backup agent stationed at agent terminal 320e.

Still referring to FIG. 3 and referring additionally to FIG. 2, a particular implementation of the inventive methodology depicted in FIG. 2 in contact center environment 300 will be described. As described above, the method can be performed through the execution of service quality program code 126 by contact center platform 312.

The process begins at block 200 and then proceeds to block 202, which illustrates establishing a mapping between factors of service quality for handling contact requests for one or more service accounts and service quality data sources within the service organization, which in this case operates contact center 310. Assuming that the conventional service quality factors of tangibility, reliability, responsiveness, assurance and empathy are employed, these service quality factors can be mapped to service quality data sources within contact center 310 as set forth in Table I in one exemplary implementation.

TABLE I

| Service Quality Factor | Internal Service Quality Data Sources |
|---|---|
| Tangibility | No. of dropped calls; avg. wait time until new |
| | request answered; avg. adherence to greeting |
| | scripts |
| Reliability | First Contact Resolution (FCR); no. of tickets |
| | (i.e., requests) pending at a given time; no. of |
| | tickets reopened |
| Responsiveness | Average Handling Time (AHT); no. of |
| | contacts made by customer for a given ticket |
| Assurance | Avg. agent process & product knowledge |
| | score; avg. agent communication score; avg. |
| | agent tenure |
| Empathy | Avg. agent soft skills score; information |
| | management score based on ease of access to |
| | customer's records and open tickets |

Again, it should be noted that all of the internal service quality data sources provide objective, quantifiable data metrics that relate to the service quality contact center 310 provides to customers that request service from contact center 310 via requester devices 102. The mapping between the internal service quality data sources and service quality factors, which is programmable and can selectively be altered, preferably forms a portion of the data set of service quality program code 126 stored within data storage 120.

At block 204, contact center platform 312 obtains internal service quality data 124 and customer satisfaction survey data 122. Unlike some embodiments, contact center platform 312 can gather internal service quality data 124 and customer satisfaction survey data 122 directly from its operations, for example, over a predetermined time interval such as a week or a month. To gather customer satisfaction survey data 122, contact center platform 312 transmits customer satisfaction (CSAT) survey 340, which is stored in data storage 120, to requester devices 102 that present service requests to contact center 310 via during the time interval. CSAT survey 340 may include one or more textual survey questions transmitted (e.g., via a web page or email) to requester devices 102 that present requests via a web page or chat. Alternatively or additionally, CSAT survey 340 can include one or more audible survey questions presented by IVR 314 to requester devices 102 that initiate voice contact with contact center 310. As noted previously, CSAT survey 340 need not be lengthy and does not directly explore the multiple dimensions of service quality, but instead focuses directly on the single metric of customer satisfaction. Thus, as a result of the operation depicted at block 204, contact center 310 obtains, for each of multiple time intervals, a respective data set of the form:

(CSAT_{avg},SQ1_{avg},SQ2_{avg}, . . . ,SQn_{avg})

where CSAT_{avg} is the average customer satisfaction figure over the time interval and SQ1_{avg} through SQn_{avg} are the average values over the time interval of the n service quality data sources mapped to service quality factors.

At block 206 of FIG. 2, contact center platform 312 determines the mathematical transformation of the average values of the service quality data sources to obtain the average customer satisfaction figure. In other words, contact center platform 312 determines a transformation function ƒ such that:

ƒ(SQ1_{avg},SQ2_{avg}, . . . ,SQn_{avg})=CSAT_{avg}

As will be appreciated, the accuracy of the mathematical transformation ƒ is improves with the number of data sets included in the computation of the transformation. Thus, if the time interval over which the customer satisfaction figure and service quality data source values are average is one week, the determination of mathematical transformation ƒ may consider a month or more of data. After the transformation function is learned in this way from the training data, it can be used to predict customer satisfaction for other time intervals of service operation or other specific service performed for a given customer.

In an alternative embodiment, the transformation function ƒ can additionally employ weights applied to each service quality factor and/or service quality data source. Thus, the transformation function ƒ can alternatively be expressed as:

ƒ(w₁*(wa₁*SQ₁a_{avg}, . . . ,wk₁*SQ₁k_{avg}), . . . ,wₙ*(waₙ*SQₙa_{avg}, . . . ,wmₙ*SQₙm_{avg}))=CSAT_{avg}

where w₁-wₙ are weights respectively applied to n service quality factors, wa₁-wk₁ are weights respectively applied to the k service quality data sources mapped to the first service quality factor, waₙ-wmₙ are weights respectively applied to the m service quality data sources mapped to the n^{th} service quality factor, SQ₁a_{avg}-SQ₁k_{avg} are the average values over the time interval of the k service quality data sources mapped to the first service quality factor, SQₙa_{avg}-SQₙm_{avg} are the average values over the time interval of the m service quality data sources mapped to the n^{th} service quality factor, and CSAT_{avg} is the average customer satisfaction figure over the time interval.

Following block 206, contact center platform 312 estimates the service quality provided by the service organization by applying the transformation determined at block 206 to at least some of internal service quality data 124 (block 210). The estimate of service quality can be determined and reported (i.e., stored, forwarded and/or output) by contact center platform 312 with any desired level of granularity, for example, for a particular ticket, for a particular service agent, for a particular skill group 330a, for a particular customer, for a given customer account, or for multiple customer accounts. It should be noted that the level of granularity at which the service quality is estimated need not be the same as that over which the transformation function is determined.

The estimate of service quality can be utilized in a variety of ways, both within and outside the service organization. For example, the estimate of service quality can be reported by contact center platform 312 to a device 102 or a data processing system of the service organization to verify compliance (optionally in a completely automated fashion) by the service organization with a SLA. Additionally, the estimate of service quality can be reported (e.g., stored in agent database 318 or transmitted to compensation determination code executed by contact center platform 312) to determine a performance-based component of the compensation for one or more service agents. Further, the estimate of service quality can be utilized to provide a service quality score for one or more service agents, which can be stored by contact center platform 312 within agent database 318. In some embodiments, this service quality score can be utilized as feedback into the transformation function as one of the internal service quality data sources. The service quality score can also be used by contact center platform 312 to flag one or more service agents in agent database 318 as exemplars of best practices (i.e., for high service quality scores) or as requiring additional training (i.e., for low service quality scores). The estimate of service quality can additionally be used to gauge the effectiveness of service agent training by comparison of service quality scores (and/or a component thereof related to a selected service quality factor) before and after training has been completed.

In a typical implementation, internal service quality data 124 is recorded on an ongoing basis at a relatively low level of granularity (e.g., per service request, per day, etc.). After the transformation function is determined from internal service quality data 124 at block 206 in a training phase, data processing system 110 enters an application phase of operation in which service quality can be estimated as frequently as desired by applying the transformation function to the internal service quality data 124 collected during the application phase. Advantageously, customer satisfaction survey data 122 need not be collected with great frequency in the application phase, but can be collected as often as desired to validate and/or update the transformation function (e.g., once a month, once per calendar quarter, etc.). In some embodiments, data processing system 110 can itself automatically determine an interval at which customer satisfaction survey data 122 is to be collected and the transformation function is to be validated and/or updated based upon the deviation between the customer satisfaction survey data 122 and the estimated service quality during one or more previous validations/updates of the transformation function.

As has been described, in at least some embodiments, a data processing system establishes a mapping between each of a plurality of plurality of internal data sources within a service organization and a respective one of multiple service quality factors. The data processing system determines a mathematical transformation of internal service quality data obtained from the plurality of internal data sources to obtain a customer satisfaction value. The data processing system estimates and reports a service quality delivered by the service organization by applying the mathematical transformation to at least some of the internal service quality data obtained from the plurality of internal data sources.

While the present invention has been particularly shown as described with reference to one or more preferred embodiments, it will be understood by those skilled in the art that various changes in form and detail may be made therein without departing from the spirit and scope of the invention. For example, although an embodiment has been described in which the survey data from which the transformation function is determined is customer satisfaction survey data, it should be appreciated that, if available, service quality survey data may alternatively or additionally be utilized as the “training data” from which the transformation function is determined.

although aspects have been described with respect to a computer system executing program code that directs the functions of the present invention, it should be understood that present invention may alternatively be implemented as a program product including a tangible, non-transient data storage medium (e.g., an optical or magnetic disk or memory) storing program code that can be processed by a data processing system to perform the functions of the present invention.

What is claimed is:

1. A method of data processing, comprising:
a data processing system establishing a mapping between each of a plurality of plurality of internal data sources within a service organization and a respective one of multiple service quality factors;
the data processing system determining a mathematical transformation of internal service quality data obtained from the plurality of internal data sources so mapped to obtain a customer satisfaction value; and
the data processing system estimating and reporting a service quality delivered by the service organization by applying the mathematical transformation to at least some of the internal service quality data obtained from the plurality of internal data sources.

2. The method of claim 1, wherein the determining includes applying a respective weight to each of the multiple service quality factors.

3. The method of claim 1, and further comprising tuning the mathematical transformation based upon an updated customer satisfaction value.

4. The method of claim 1, and further comprising obtaining the customer satisfaction value from customer surveys.

5. The method of claim 1, and further comprising verifying compliance of the service organization with a service level agreement based on the estimated service quality.

6. The method of claim 1, wherein the reporting includes storing the estimated service quality in an agent database in association with records for one or more service agents.

7. A data processing system, comprising:
a processor;
data storage coupled to the processor; and
program code within the data storage that, when executed by the processor, causes the data processing system to perform:
establishing a mapping between each of a plurality of plurality of internal data sources within a service organization and a respective one of multiple service quality factors;
determining a mathematical transformation of internal service quality data obtained from the plurality of internal data sources to obtain a customer satisfaction value; and
estimating and reporting a service quality delivered by the service organization by applying the mathematical transformation to at least some of the internal service quality data obtained from the plurality of internal data sources.

8. The data processing system of claim 7, wherein the determining includes applying a respective weight to each of the multiple service quality factors.

9. The data processing system of claim 7, wherein the program code further causes the data processing system to perform:
tuning the mathematical transformation based upon an updated customer satisfaction value.

10. The data processing system of claim 7, wherein the program code further causes the data processing system to perform:
obtaining the customer satisfaction value from customer surveys.

11. The data processing system of claim 7, wherein the program code further causes the data processing system to perform:
verifying compliance of the service organization with a service level agreement based on the estimated service quality.

12. The data processing system of claim 7, wherein the reporting includes storing the estimated service quality in an agent database in association with records for one or more service agents.

13. A program product, comprising:
a computer-readable storage medium; and
program code within the computer-readable storage medium that, when executed by a computer, causes the computer to perform:
establishing a mapping between each of a plurality of plurality of internal data sources within a service organization and a respective one of multiple service quality factors;
determining a mathematical transformation of internal service quality data obtained from the plurality of internal data sources to obtain a customer satisfaction value;
estimating and reporting a service quality delivered by the service organization by applying the mathematical transformation to at least some of the internal service quality data obtained from the plurality of internal data sources.

14. The program product of claim 13, wherein the determining includes applying a respective weight to each of the multiple service quality factors.

15. The program product of claim 13, wherein the program code further causes the computer to perform:
tuning the mathematical transformation based upon an updated customer satisfaction value.

16. The program product of claim 13, wherein the program code further causes the computer to perform:
obtaining the customer satisfaction value from customer surveys.

17. The program product of claim 13, wherein the program code further causes the computer to perform:
verifying compliance of the service organization with a service level agreement based on the estimated service quality.

18. The program product of claim 13, wherein the reporting includes storing the estimated service quality in an agent database in association with records for one or more service agents.
